(19) United States
(12) Patent Application Publication
(10) Pub. No.: US 2026/0257472 A1
(43) Pub. Date: Sep. 3, 2026

(54) LIQUID EJECTION APPARATUS, INSPECTION APPARATUS, AND LIQUID EJECTION HEAD

(71) Applicant: CANON KABUSHIKI KAISHA, Tokyo (JP)

(72) Inventors: YOSUKE TAKAGI, Kanagawa (JP); YUJI TAMARU, Tokyo (JP); KIMIYUKI HAYASAKI, Kanagawa (JP); TAKAMITSU TOKUDA, Kanagawa (JP)

(21) Appl. No.: 19/464,971

(22) Filed: Jan. 30, 2026

(30) Foreign Application Priority Data
Feb. 27, 2025 (JP) 2025-030003

(51) Int. Cl. B41J 2/045; B41J 2/175; B41J 2/18; B41J 25/34

(52) U.S. Cl. CPC B41J 2/0451; B41J 2/04586; B41J 2/17596; B41J 2/18; B41J 25/34; B41J 2202/12; B41J 2202/14

(57) ABSTRACT

A liquid ejection apparatus includes a liquid ejection head and a detection unit electrically connectable to the liquid ejection head. The liquid ejection head includes: a circulation channel configured to have liquid be circulate, and a circulation pump including a piezoelectric element and configured to control a circulation flow rate of the liquid circulating through the circulation channel by shape change of the piezoelectric element in accordance with an electric signal. The detection unit detects an electric connection state of the piezoelectric element based on a discharge signal generated with discharging of a charge stored in the piezoelectric element by the electric signal.

### BACKGROUND

### Field of the Technology

The present disclosure relates to an inspection technique of a liquid ejection head.

### Description of the Related Art

An ink circulation type inkjet head (hereinafter, also referred to as liquid ejection head) has been conventionally known. Japanese Patent Laid-Open No. 2018-30350 (hereinafter, referred to as Literature 1) discloses a technique as follows. Ink (hereinafter, also referred to as liquid) stored in an ink tank is supplied to a liquid ejection head, part of the ink is ejected, and the not-ejected ink is returned to the ink tank.

A piezoelectric pump (hereinafter, also referred to as circulation pump) configured to deliver the ink (hereinafter, also referred to as liquid) is provided inside the liquid ejection head described in Literature 1. The circulation pump is driven by a drive signal generated by an electric substrate provided inside the liquid ejection head. Since it is cumbersome to perform electric connection inspection of the circulation pump after attachment of the circulation pump to the liquid ejection head in a manufacturing process of the liquid ejection head, there is a demand for making a configuration for the electric connection inspection of the circulation pump simple.

### SUMMARY

A liquid ejection apparatus according to one aspect of the present disclosure includes: a liquid ejection head; and a detection unit electrically connectable to the liquid ejection head, the liquid ejection head includes: a circulation channel configured to have liquid be circulate; and a circulation pump including a piezoelectric element and configured to control a circulation flow rate of the liquid circulating through the circulation channel by shape change of the piezoelectric element in accordance with an electric signal, and the detection unit detects an electric connection state of the piezoelectric element based on a discharge signal generated with discharging of a charge stored in the piezoelectric element by the electric signal.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic perspective diagram of a liquid ejection apparatus;

FIG. 1B is a block diagram of a control system of the liquid ejection apparatus in FIG. 1A;

FIG. 2 is an exploded perspective diagram of a liquid ejection head of FIG. 1A in a first embodiment;

FIG. 3 is an external schematic diagram of an ink circulation unit of FIG. 2 in the first embodiment;

FIG. 4 is a schematic diagram of a circulation channel in the liquid ejection head of FIG. 1A in the first embodiment;

FIG. 5 is a diagram illustrating a wiring example of a circulation pump of FIG. 4 in the first embodiment;

FIG. 6 is a cross-sectional schematic diagram of the circulation pump of FIG. 5 in the first embodiment;

FIG. 7 is a diagram illustrating a configuration schematic diagram of a pump drive circuit that drives the circulation pump of FIG. 6 in the first embodiment;

FIG. 8 is a diagram illustrating another configuration schematic diagram of the pump drive circuit that drives the circulation pump of FIG. 6 in the first embodiment;

FIG. 9 is a diagram illustrating a circuit configuration example of a booster circuit of FIGS. 7 and 8 in the first embodiment;

FIG. 10 is a diagram illustrating a circuit configuration example of an output switching circuit of FIGS. 7 and 8 in the first embodiment;

FIG. 11 is a timing chart of control signals for controlling the pump drive circuit of FIGS. 7 and 8 in the first embodiment;

FIG. 12 is a diagram explaining an operation principle of detecting an electric connection state of the circulation pump and an electric capacitance of a piezoelectric element in the first embodiment;

FIG. 13 is a diagram illustrating an example of a maximum value output circuit for obtaining a maximum value of a pump inspection signal of FIG. 12 in the first embodiment;

FIG. 14 is a diagram illustrating an example of an integration circuit for obtaining an integrated value of the pump inspection signal of FIG. 12 in the first embodiment;

FIG. 15 is a diagram illustrating a configuration schematic diagram of a pump drive circuit that drives the circulation pump of FIG. 6 in a second embodiment; and

FIG. 16 is a schematic diagram explaining a configuration example in each of phases of assembly, inspection, and shipping of the liquid ejection head in a third embodiment.

### DESCRIPTION OF THE EMBODIMENTS

Preferable embodiments of the present disclosure are explained below in detail with reference to the attached drawings. Note that the following embodiments do not limit the matters of the present disclosure, and not all of combinations of features explained in the following embodiments are necessarily essential for the solving means of the present disclosure. Note that the same constituent elements are denoted by the same signs.

### Outline

Printers that use various printing methods as a printing method for printing an image on a print medium such as a business form or a long sheet have been conventionally put into practical use. For example, printers of a thermal transfer method, a wire dot method, a thermal sensitive method, an inkjet method, and the like are put into practical use. The printer of the inkjet method among these various printing methods is attracting attention due to its low running cost and its ability to suppress printing noise, and is used in a wide variety of fields. Note that, in the following explanation, a print medium subjected to printing by the printer of inkjet method is referred to as printed medium as appropriate.

The printer of inkjet method includes a liquid ejection head. The liquid ejection head includes an ejection element substrate. A nozzle member provides ejection orifices of inks on a surface of the ejection element substrate. Ejection energy generation elements are arranged at positions corresponding to the ejection orifices of the inks. Driving the ejection energy generation elements causes ink droplets to be ejected from the ejection orifices. An image is formed by causing these ink droplets to land at desired positions on the printed medium.

In recent years, in the inkjet printer field using the printer of inkjet method, there is a demand for an ink circulation type printer that can use a special ink suiting the printed medium to output a print product with high quality also in a liquid ejection head scanning type printer. For such a printer, there is proposed a configuration in which an ink supplying channel and an ink collecting channel are provided for circulation of the ink, and a differential pressure is generated between the ink supplying channel and the ink collecting channel to obtain a circulatory flow of the ink.

For example, there is disclosed a printer including a reservoir portion that supplies the ink to the liquid ejection head, a reservoir portion that allows the ink to flow back from the liquid ejection head, a circulation pump that conveys the ink between the two reservoir portions, a pressure sensor, and a control circuit, in the liquid ejection head. In this printer, the control circuit performs control of driving the circulation pump according to output of the pressure sensor.

An electric substrate is provided in such a liquid ejection head. This electric substrate generates a drive signal for driving the circulation pump. The generated drive signal is transmitted to the circulation pump via an electric connection portion electrically connected to the electric substrate in the liquid ejection head. Accordingly, whether the electric substrate and the circulation pump are normally, electrically connected to each other is desirably inspected in a manufacturing process of the liquid ejection head.

However, it is cumbersome to provide an electric connection point in a portion where a signal with the same potential as the electric connection portion is detectable and directly detect the electrical signal from this connection point to inspect an electric connection state between the electric substrate and the circulation pump after assembling of the circulation pump to the liquid ejection head. Accordingly, there is a demand for simple inspection. Moreover, it is desirable that the electric connection state between the electric substrate and the circulation pump can be inspected also after mounting of the liquid ejection head in the printer.

Accordingly, in the present disclosure, a liquid ejection apparatus includes a liquid ejection head and a detection unit electrically connectable to the liquid ejection head. The liquid ejection head includes a circulation channel and a circulation pump. Liquid circulates through the circulation channel. The circulation pump includes a piezoelectric element, and controls a circulation flow rate of the liquid circulating through the circulation channel by means of shape change of the piezoelectric element according to an electric signal. The detection unit detects an electric connection state of the piezoelectric element based on a discharge signal generated with discharging of a charge stored in the piezoelectric element by the electric signal. According to such a configuration, the discharge signal in the case where the charge is discharged from the piezoelectric element can be detected from the outside of the liquid ejection head. Accordingly, whether the piezoelectric element is normally, electrically connected or not can be inspected in a simple way without provision of an electric connection point in a portion where a signal with the same potential as an electric connection portion electrically connected to an electric substrate in the liquid ejection head is detectable. Moreover, in the above-mentioned configuration, it is possible to measure the discharge signal and inspect the electric connection state of the piezoelectric element on the main body side of the liquid ejection apparatus also after mounting of the liquid ejection head in the liquid ejection apparatus.

Moreover, the piezoelectric element is arranged in the circulation pump. The shape of the piezoelectric element is displaced according to the electric signal, and the piezoelectric element thereby generates a circulatory flow of the ink. Accordingly, the circulation flow rate of the ink varies depending on an electric capacitance of the piezoelectric element (hereinafter, also referred to as piezoelectric capacitance). However, in the piezoelectric element, there is manufacturing variation among individual bodies. Accordingly, even if a predetermined electric signal is applied to the piezoelectric elements, the circulation flow rates of circulatory flows of the ink generated by the respective piezoelectric elements may vary. The circulation flow rate of the ink is desirably guaranteed to be high enough to remove bubbles generated in the circulation channel through which the ink circulates. Alternatively, the circulation flow rate of the ink is desirably guaranteed to be high enough to enable normal ejection without an effect of evaporation of the ink also in a nozzle with low ejection frequency. To this end, it is desirable that the piezoelectric element can provide a certain level of circulation flow rate. Moreover, in the case where variation in the piezoelectric capacitance is large, a setting center value of the circulation flow rate of the ink is preferably set high. Meanwhile, in the case where the circulation flow rate is uniformly set high, in a system in which the ink is heated to predetermined temperature, the ink tends to be cooled due to an increase in the circulation flow rate of the ink, and there is possibility that more electric power is consumed to heat the ink. Specifically, the power consumption of the liquid ejection head increases, and if a power supply with a higher power supply capacity is installed to handle this increased power consumption, there is a concern that this leads to an increase in cost. Accordingly, there is a case where maintaining the circulation flow rate at a certain level is desirable irrespective of variation in the piezoelectric capacitance among individual bodies.

In the present disclosure, the electric capacitance of the piezoelectric element can be measured by obtaining a time integration of a pump inspection signal obtained by dividing a potential of the discharge signal. Accordingly, performing control based on the measured electric capacitance of the piezoelectric element also enables control of maintaining a circulation flow rate at a certain level irrespective of variation in the electric capacitance of the piezoelectric element among individual bodies. The present disclosure is specifically explained below.

### First Embodiment

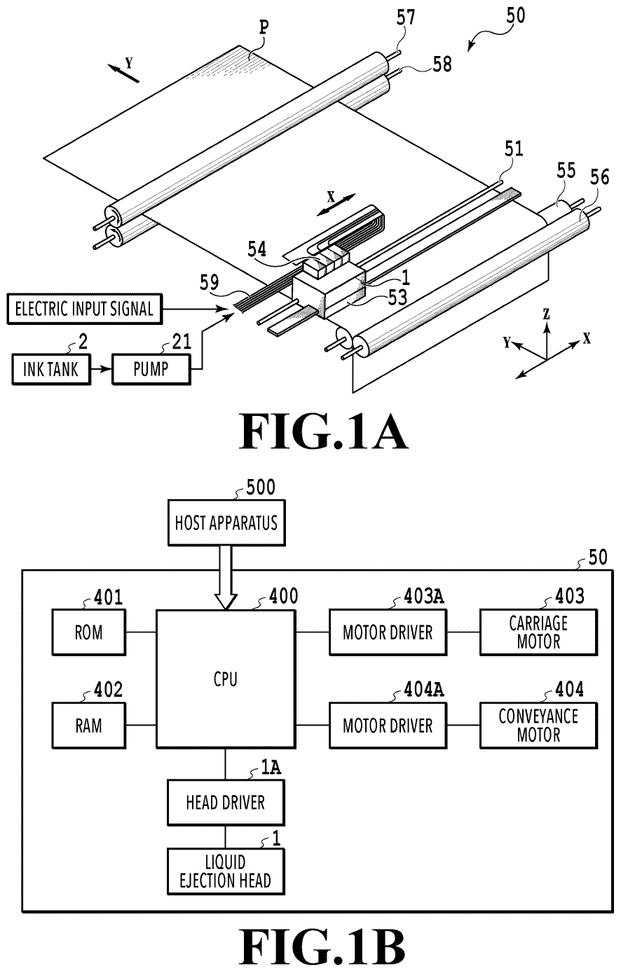

FIGS. 1A and 1B are diagrams illustrating a schematic configuration example of a liquid ejection apparatus 50 in the first embodiment. FIG. 1A is a schematic perspective diagram of the liquid ejection apparatus 50. FIG. 1B is a block diagram of a control system of the liquid ejection apparatus 50 in FIG. 1A. The liquid ejection apparatus 50 includes a liquid ejection head 1 and conveyance rollers 55, 56, 57, and 58. The liquid ejection head 1 can perform scanning in a direction X intersecting a conveyance direction Y of an ejection target medium P. In the example of FIG. 1A, the liquid ejection head 1 is mounted in a carriage 53. The carriage 53 is reciprocally moved in a main scanning direction (also referred to as direction X) along a guide shaft 51. The conveyance rollers 55, 56, 57, and 58 convey the ejection target medium P in a sub scanning direction (also referred to as conveyance direction Y) intersecting (orthogonal to in the present example) the main scanning direction. Specifically, the liquid ejection apparatus 50 ejects liquid from the liquid ejection head 1 to the ejection target medium P conveyed in the conveyance direction Y while performing scanning of the liquid ejection head 1 in the direction X to form a serial type inkjet liquid ejection apparatus. Note that application of the present disclosure is not limited to the serial type inkjet liquid ejection apparatus. The present disclosure can be also applied to a page wide type inkjet liquid ejection apparatus that ejects the liquid to the ejection target medium P conveyed in the conveyance direction Y by using a line head (page wide type head) elongating in a page width direction of the ejection target medium P. In FIG. 1A, a direction Z indicates the vertical direction. Specifically, the direction Z is a direction that intersects (orthogonal to in the present example) an XY plane defined by the direction X and the conveyance direction Y. Note that, in the following explanation, the direction X, the conveyance direction Y, and the direction Z are used in the same meaning as the above-mentioned contents.

The liquid ejection head 1 can eject four types of inks of black (K), cyan (C), magenta (M), and yellow (Y). The liquid ejection head 1 can eject a full-color image by using these four types of inks. Note that the inks that can be ejected from the liquid ejection head 1 are not limited to the above-mentioned four types of inks. For example, the present disclosure can be also applied to a liquid ejection head 1 for ejecting other types of inks such as particular color inks. Specifically, the types and the number of inks ejected from the liquid ejection head 1 are not limited. Moreover, a cap member that covers a face surface of the liquid ejection head 1 may be arranged at a position outside a conveyance path of the ejection target medium P. The cap member is moved to a position where it covers the face surface of the liquid ejection head 1, relative to the face surface in the case where a printing operation is not performed. This operation prevents drying of ejection orifices of the liquid in the liquid ejection head 1, or enables execution of a suction operation for filling or recovery.

In the example of FIG. 1A, ink circulation units 54 are mounted in the liquid ejection head 1. A guide 59 housing four ink supply tubes (liquid communication channels) is attached to the ink circulation units 54. The guide 59 houses electric wiring and air piping necessary for ejection of the liquid in addition to the ink supply tubes. Moreover, ink tanks 2 and pumps 21 are provided on the main body (not illustrated) side of the liquid ejection apparatus 50. The ink tanks 2 store the inks. The inks stored in the ink tanks 2 are supplied to the ink circulation units 54 via the four ink supply tubes by drive force of the pumps 21. The liquid ejection head 1 may be configured to be provided integrally with the ink circulation units 54 and be attachable to and detachable from the carriage 53. Alternatively, the configuration may be such that the liquid ejection head 1 is provided integrally with the carriage 53 and only the ink circulation units 54 are attachable and detachable. Note that, in the following explanation, explanation is given of an example in which the liquid ejection head 1 includes the ink circulation units 54.

A CPU 400 in FIG. 1B performs various types of control of the liquid ejection apparatus 50. A ROM 401 stores programs for processing procedures and the like. The CPU 400 obtains the programs for the processing procedures and the like from the ROM 401. The CPU 400 controls the liquid ejection apparatus 50 based on the program obtained from the ROM 401. The CPU 400 uses a RAM 402 as a work area for executing the programs obtained from the ROM 401. The CPU 400 obtains image data from a host apparatus 500 provided outside the liquid ejection apparatus 50. The CPU 400 controls a head driver 1A based on the image data obtained from the host apparatus 500. The head driver 1A controls ejection of the liquid by the liquid ejection head 1. The CPU 400 controls a motor driver 403A. The motor driver 403A controls a carriage motor 403. The carriage motor 403 moves the carriage 53 along the X direction. The CPU 400 controls a motor driver 404A. The motor driver 404A controls a conveyance motor 404. The conveyance motor 404 controls the conveyance rollers 55, 56, 57, and 58. The conveyance rollers 55, 56, 57, and 58 conveys the ejection target medium P along the conveyance direction Y.

### Liquid Ejection Head 1

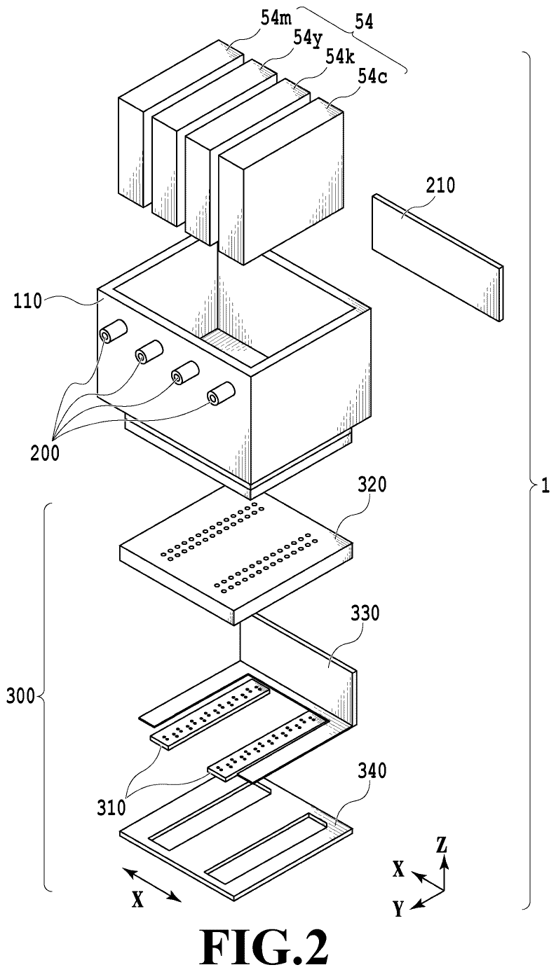

FIG. 2 is an exploded perspective diagram of the liquid ejection head 1 of FIG. 1A in the first embodiment. The liquid ejection head 1 includes a channel member 110, the ink circulation units 54, and an ejection unit 300. The ink circulation units 54 are at least partially housed in the channel member 110, and are connected to the channel member 110. The ejection unit 300 is provided in a bottom portion of the channel member 110, and is connected to the channel member 110. Specifically, the ink circulation units 54 are formed of the ink circulation units 54m, 54y, 54k, and 54c corresponding to the respective inks. In the case where the ink circulation units 54m, 54y, 54k, and 54c are not particularly distinguished from one another, the ink circulation units 54m, 54y, 54k, and 54c are referred to as the ink circulation units 54. Each of the ink circulation units 54 is housed in and connected to the channel member 110. The channel member 110 and each of the ink circulation units 54 may be connected to each other by a screw-fastening method with a sealing member interposed between the channel member 110 and the ink circulation unit 54. Alternatively, the channel member 110 and each of the ink circulation units 54 may be connected to each other by welding. The channel member 110 has a surface provided with four joints 200 connected to the respective four ink supply tubes corresponding to the four types of inks. In other words, an individual ink supplying channel is provided for each type of ink. Specifically, the ink circulation units 54m, 54y, 54k, and 54c are connected, respectively, to the ink supply tubes corresponding to the respective inks and extending from the main body side of the liquid ejection apparatus 50, via the respective joints 200. The inks supplied from the respective corresponding ink supply tubes are supplied to the respective ink circulation units 54 via the joints 200. The inks supplied to the respective ink circulation units 54 are supplied to the ejection unit 300 via the channel member 110.

The ejection unit 300 includes ejection element substrates 310, a support member 320, an electric wiring substrate 330, and a cover member 340. The ejection element substrates 310 and the electric wiring substrate 330 are bonded and fixed to the support member 320. The cover member 340 is bonded and joined to the electric wiring substrate 330 to cover a surface of the electric wiring substrate 330. Portions of the cover member 340 corresponding to the ejection element substrates 310 are opened. The ejection element substrates 310 include actuators for ejecting the inks. Accordingly, the ejection element substrates 310 can eject the liquid to the ejection target medium P passing under the liquid ejection head 1. Note that the ejection unit 300 and the channel member 110 are bonded to each other by using adhesive. Alternatively, the ejection unit 300 and the channel member 110 may be fixed to each other by screw-fastening with a sealing member interposed therebetween.

The ejection element substrates 310 and the electric wiring substrate 330 are electrically connected to one another by wire bonding. The electric wiring substrate 330 sends various electric signals to the ejection element substrates 310. The ejection element substrates 310 eject the liquid by using a drive voltage supplied from the head driver 1A, according to the various electric signals from the electric wiring substrate 330. Details of the various electric signals are described later. Note that the ejection element substrates 310 and the electric wiring substrate 330 may be electrically connected to one another by flying lead bonding or the like.

A contact surface is provided on the opposite side of the channel member 110 to the surface provided with the joints 200. A head substrate 210 is connected to the contact surface. The head substrate 210 and the channel member 110 may be fixed to each other by crimping, adhesive, or two-sided adhesive tape. The head substrate 210 receives electric signals from the main body of the liquid ejection apparatus 50. The head substrate 210 and the electric wiring substrate 330 are electrically connected to each other by anisotropic conductive film (ACF) bonding. The head substrate 210 and the electric wiring substrate 330 may be electrically connected to each other by wire bonding. Alternatively, the head substrate 210 and the electric wiring substrate 330 may be electrically connected to each other by flying lead bonding. The electric signals received by the head substrate 210 are sent to the ejection element substrates 310 via the electric wiring substrate 330.

Note that the present disclosure preferably operates also in the case where the ink circulation units 54 are provided inside the liquid ejection apparatus and outside the liquid ejection head 1. However, in a form in which circulation pumps 27 are provided inside the liquid ejection head 1, since a pump performance is limited due to size restriction of the circulation pumps 27, effects of the present disclosure can be especially obtained.

### Circulation Channel

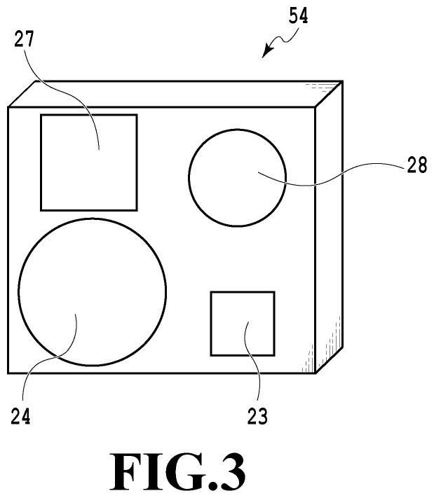

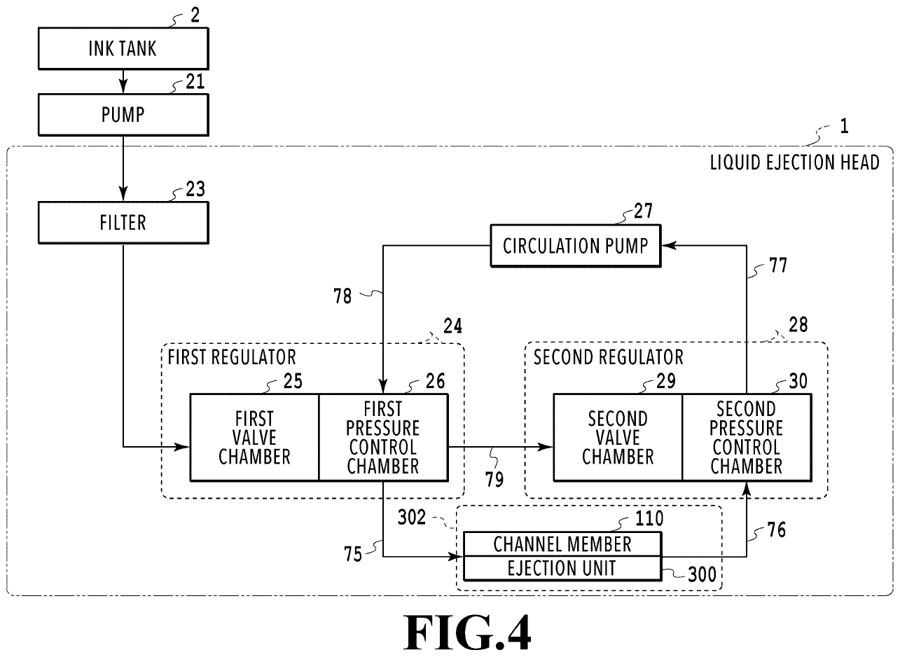

FIG. 3 is an external schematic diagram of each of the ink circulation units 54 in FIG. 2 in the first embodiment. One ink circulation unit 54 is provided for each color. Each ink circulation unit 54 includes a first regulator 24, a second regulator 28, a filter 23, and the circulation pump 27. FIG. 4 is a schematic diagram of the circulation channel in the liquid ejection head 1 of FIG. 1A in the first embodiment. The circulation channel of FIG. 4 is the circulation channel for one color. The circulation channel of FIG. 4 is provided for each ink in the liquid ejection head 1. The ink tank 2 and the pump 21 are provided on the main body side of the liquid ejection apparatus 50. The first regulator 24 includes a first valve chamber 25 and a first pressure control chamber 26. The first valve chamber 25 and the first pressure control chamber 26 communicate with each other via a not-illustrated valve. The second regulator 28 includes a second valve chamber 29 and a second pressure control chamber 30. The second valve chamber 29 and the second pressure control chamber 30 communicate with each other via a not-illustrated valve. The circulation pump 27 and the first pressure control chamber 26 communicate with each other via a pump outlet channel 78. The first pressure control chamber 26 and the channel member 110 communicate with each other via a supplying channel 75. Part of the channel member 110 may form the supplying channel 75. The channel member 110 and the second pressure control chamber 30 communicate with each other via a collecting channel 76. Part of the flow member may form the collecting channel 76. The second pressure control chamber 30 and the circulation pump 27 are connected to each other via a pump inlet channel 77. Specifically, the circulation channel formed of the first pressure control chamber 26, the supplying channel 75, the channel member 110, the collecting channel 76, the second pressure control chamber 30, the pump inlet channel 77, the circulation pump 27, and the pump outlet channel 78 is formed. The ink can circulate through this circulation channel. Moreover, the channel member 110 and the ejection unit 300 form an ejection module 302. Note that a bypass channel 79 that bypasses the ink circulation channel by extending from the first pressure control chamber 26 to the second valve chamber 29 is provided between the first pressure control chamber 26 and the second valve chamber 29. Details of the bypass channel 79 are described later. Next, details of the circulation pump 27 are explained, and then a flow of the ink circulating through the circulation channel is explained.

### Drive Mechanism of Circulation Pump 27

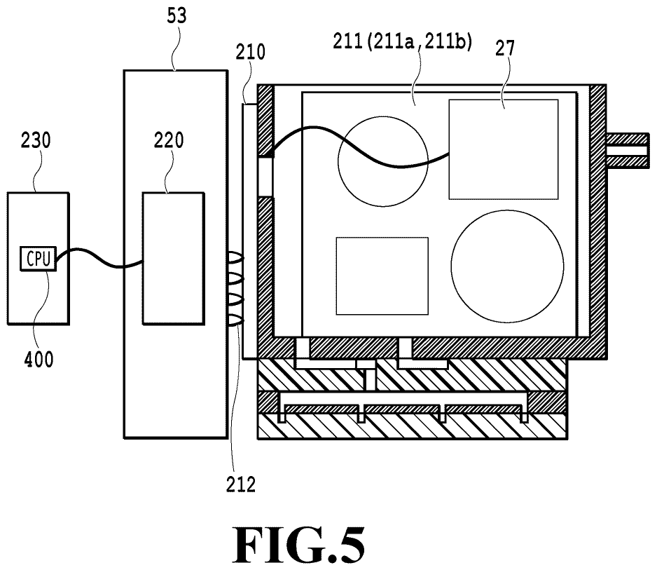

FIG. 5 is a diagram illustrating a wiring example of the circulation pump 27 of FIG. 4 in the first embodiment. The liquid ejection apparatus 50 includes a main substrate 230, a carriage substrate 220, and the head substrate 210. The main substrate 230 is provided in the main body of the liquid ejection apparatus 50. The CPU 400 is mounted on the main substrate 230. The carriage substrate 220 is provided in the carriage 53. The main substrate 230 and the carriage substrate 220 are connected to each other via a flexible flat cable (FFC). Drive signals are sent from the CPU 400 to the carriage substrate 220 via the FFC. The carriage substrate 220 and the head substrate 210 are connected to each other via an electric connection portion 212 by using contacts. Pump control signals and a pump drive reference voltage are supplied from the carriage substrate 220 to the head substrate 210 via the electric connection portion 212. The head substrate 210 and the circulation pump 27 are connected to each other via a harness 211. The harness 211 is formed of a cable assembly including a first wiring line 211a and a second wiring line 211b. Pump drive signals 608 generated based on pump control signals 605 and a pump drive voltage 607 generated from a pump drive reference voltage 604 are supplied to the circulation pump 27 via the harness 211. The circulation pump 27 is driven based on the pump drive signals 608. The liquid in the liquid ejection head 1 is circulated by the drive of the circulation pump 27. Details of the pump control signals 605, the pump drive reference voltage 604, the pump drive voltage 607, and the pump drive signals 608 are described later. Note that the head substrate 210 and the carriage substrate 220 may be electrically connected to each other by being fixed by ACF bonding. Next, a configuration of the circulation pump 27 is explained.

### Internal Configuration of Circulation Pump 27

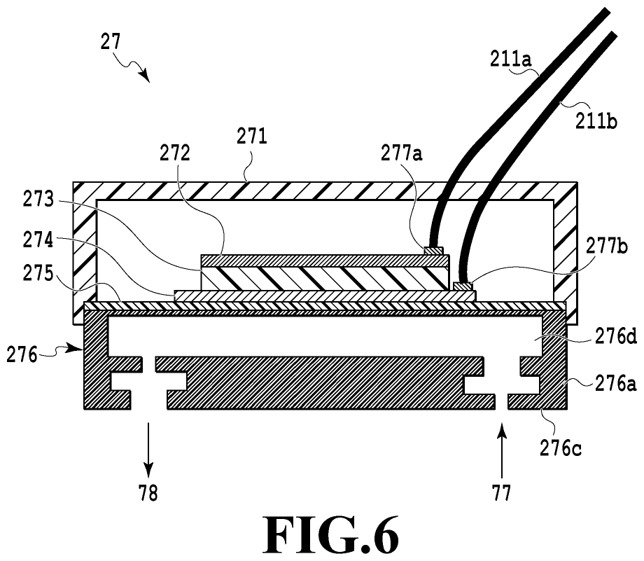

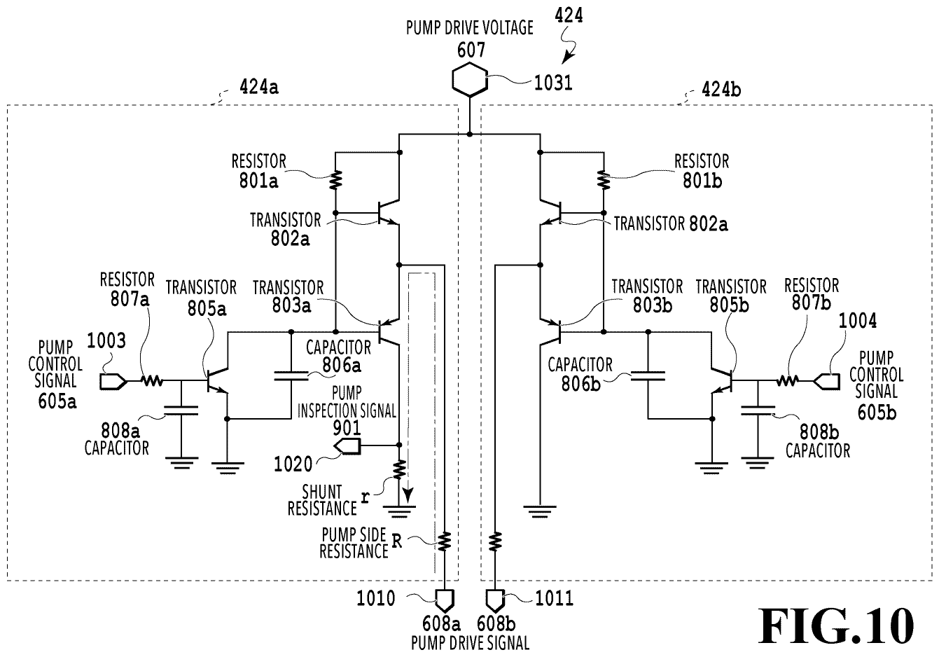

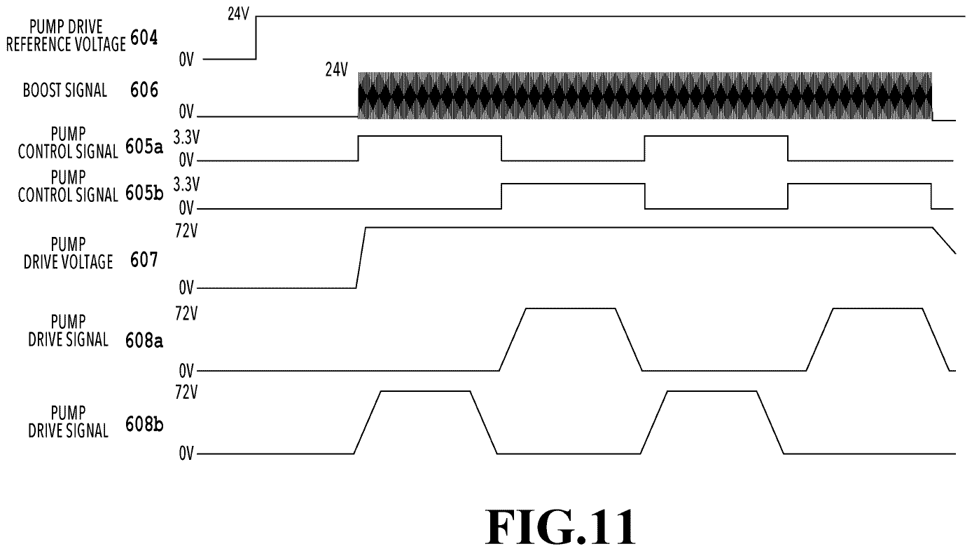

FIG. 6 is a cross-sectional schematic diagram of the circulation pump of FIG. 5 in the first embodiment. The circulation pump 27 includes a pump case 271, a diaphragm unit 276, a first electrode 272, a piezoelectric element 273, a second electrode 274, and a diaphragm 275. The piezoelectric element 273 is provided between the first electrode 272 and the second electrode 274. One surface of the piezoelectric element 273 is in contact with the first electrode 272. The other surface of the piezoelectric element 273 is in contact with the second electrode 274. The first wiring line 211a is connected to the first electrode 272 via an electric connection member 277a. The first wiring line 211a is a signal medium that transmits a pump control signal 605a and a pump drive signal 608a to the circulation pump 27. The second wiring line 211b is connected to the second electrode 274 via an electric connection member 277b. The second wiring line 211b is a signal medium that transmits a pump control signal 605b and a pump drive signal 608b to the circulation pump 27. The electric connection members 277a and 277b are solder in the present embodiment, but is not particularly limited to solder. Conductive members such as gold bumps may be used as the electric connection members 277a and 277b. Details of the pump control signals 605a and 605b and the pump drive signals 608a and 608b are described later by using FIGS. 10 and 11. Moreover, one surface of the second electrode 274 is in contact with the piezoelectric element 273, and the other surface is in contact with the diaphragm 275. Specifically, a laminate in which the first electrode 272, the piezoelectric element 273, the second electrode 274, and the diaphragm 275 are stacked one on top of the other in this order is formed. A recess-shaped pump case 271 is provided to cover this laminate. Moreover, the diaphragm unit 276 is provided on a surface of the diaphragm 275 on the opposite side to a surface on which the laminate is formed out of the two surfaces of the diaphragm 275. The diaphragm unit 276 includes a diaphragm unit case 276a, a valve element 276b, and a valve element 276c. The diaphragm unit case 276a is formed of a recess-shaped case. An edge of the recess shape of the diaphragm unit case 276a and an edge of the diaphragm 275 are fixed to each other while being brought into contact with each other to from a pressure chamber 276d. Specifically, the pressure chamber 276d is arranged in a state in close contact with the diaphragm 275. A flow-in port and a flow-out port are provided in a bottom portion of the diaphragm unit case 276a. The valve element 276b (also referred to as flow-out-side valve element 276b) is arranged in the flow-out port. The valve element 276c (also referred to as flow-in-side valve element 276c) is arranged in the flow-in port. The valve element 276b functions as a check valve that can freely move in response to flow-out of the liquid from the pressure chamber 276d. The valve element 276c functions as a check valve that can freely move in response to flow-in of the liquid into the pressure chamber 276d. The pump outlet channel 78 of FIG. 5 is arranged at a position where the pump outlet channel 78 faces the valve element 276b with the flow-out port arranged therebetween. The pump inlet channel 77 of FIG. 5 is arranged at a position where the pump inlet channel 77 faces the valve element 276c with the flow-in port arranged therebetween. Next, the flow of the ink is explained by using FIG. 5.

### Flow of Ink

Returning to FIG. 4, the pump 21 of FIG. 4 supplies the ink stored in the ink tank 2 to the liquid ejection head 1 by pressurizing the ink. The filter 23 removes dust included in the ink pressurized and supplied from the pump 21. The ink from which the dust is removed by the filter 23 is supplied to the first valve chamber 25. In the case where the ink supplied to the first valve chamber 25 flows into the first pressure control chamber 26, the pressure of the ink is controlled by the circulation pump 27. Next, details of control of the pressure by the circulation pump 27 are explained by using FIG. 6.

Generating a potential difference by applying a voltage to the piezoelectric element 273 of FIG. 6 causes the piezoelectric element 273 to vibrate, and this vibration moves the diaphragm 275 and changes the volume of the inside of the pressure chamber 276d to cause pressure fluctuation inside the pressure chamber 276d. The pressure fluctuation inside the pressure chamber 276d causes the two valve elements 276b and 276c to alternately move and send the ink, and the circulation pump 27 thereby functions as a piezoelectric diaphragm pump. The circulation pump 27 is driven to send the ink with the pump inlet channel 77 being the downstream side and the pump outlet channel 78 being the upstream side. The explanation returns to FIG. 4. The drive of the circulation pump 27 of FIG. 4 causes the ink whose pressure is controlled inside the first pressure control chamber 26 to be supplied to the supplying channel 75 and the bypass channel 79. The supplying channel 75 supplies the ink to the channel member 110. The channel member 110 supplies the ink supplied from the supplying channel 75, to the ejection unit 300. The ink supplied to the ejection unit 300 is supplied to the ejection element substrate 310 inside the ejection unit 300. Ejection elements are provided in the ejection element substrate 310. The ink supplied to the ejection element substrate 310 passes the ejection elements, and is then discharged to the collecting channel 76. Each of the ejection elements includes an energy generation element, a pressure chamber, and an ejection orifice. The ink passing the pressure chamber inside the ejection element and discharged to the collecting channel 76 is supplied to the second pressure control chamber 30. Moreover, the ink supplied to the second valve chamber 29 via the bypass channel 79 is supplied to the second pressure control chamber 30 communicating with the second valve chamber 29 via the valve connecting the second valve chamber 29 and the second pressure control chamber 30 to each other. Accordingly, the ink is supplied to the second pressure control chamber 30 from both of the collecting channel 76 and the bypass channel 79. The ink supplied to the second pressure control chamber 30 is supplied to the circulation pump 27 via the pump inlet channel 77. The ink supplied to the circulation pump 27 is supplied to the first pressure control chamber 26 via the pump outlet channel 78. As described above, the circulation pump 27 causes the ink to pass the ejection elements formed in the ejection element substrate 310 and circulate. Specifically, the configuration of the circulation channel can suppress thickening of the ink around the ejection elements. The circulation channel is not limited to a configuration in which the circulation channel extends via the ejection elements. For example, the circulation channel may be configured to allow the ink to circulate inside the ejection unit 300 within a scope in which the effect of suppressing thickening of the ink around the ejection elements is provided.

Note that the ejection unit 300 is provided with a not-illustrated temperature sensor and a heater. The CPU 400 drives the heater as necessary while monitoring an output value of the temperature sensor provided in the ejection unit 300. This operation can maintain temperature of the ejection unit 300 in a state preferable for liquid ejection. Moreover, in the present disclosure, the ejection unit 300 preferably operates also without the temperature sensor or the heater. However, in the case where the ejection unit 300 includes the temperature sensor and the heater, power required for heat retention by the heater increases as the circulation flow rate of the ink increases. Accordingly, the effect of the present disclosure can be especially exhibited. Next, flow-in and flow-out of the ink are explained based on the following first to third use cases by using FIG. 6.

### First Use Case

A first use case in which the ink flows into the pressure chamber 276d is explained. Assume a case where a potential difference is generated in a direction from the second electrode 274 to the first electrode 272, and the piezoelectric element 273 and the diaphragm 275 are displaced in a direction in which the pressure chamber 276d expands. In this assumed case, the valve element 276c opens, and the ink flows in from the pump inlet channel 77 to the pressure chamber 276d.

### Second Use Case

A second use case in which the ink flows out from the pressure chamber 276d is explained. Assume a case where a potential difference is generated in a direction from the first electrode 272 to the second electrode 274, and the piezoelectric element 273 and the diaphragm 275 are displaced in a direction in which the pressure chamber 276d contracts. In this assumed case, the valve element 276b opens, and the ink flows out from the pressure chamber 276d to the pump outlet channel 78.

### Third Use Case

A third use case in which neither the flow-in of the ink into the pressure chamber 276d or the flow-out of the ink from the pressure chamber 276d occurs is explained. Assume a case where no potential difference occurs between the first electrode 272 and the second electrode 274. In this assumed case, the piezoelectric element 273 and the diaphragm 275 are displaced in neither the direction in which the pressure chamber 276d expands or the direction in which the pressure chamber 276d contracts. Accordingly, neither the flow-in of the ink into the diaphragm unit 276 or the flow-out of the ink from the diaphragm unit 276 occurs.

Specifically, periodically changing the potential difference between the first electrode 272 and the second electrode 274 causes the circulation pump 27 to cause the ink to flow in from the pump inlet channel 77 and to flow out from the pump outlet channel 78. In the circulation pump 27 as described above, for example, there is a possibility that manufacturing variation in the piezoelectric element 273 affects a liquid delivery performance of the circulation pump 27. Specifically, there is a possibility that an electrostatic capacitance of the piezoelectric element 273 affects a displacement speed of the piezoelectric element 273 in the case where a certain potential difference is provided between the first electrode 272 and the second electrode 274. Accordingly, there is a possibility that the manufacturing variation in the piezoelectric element 273 affects the liquid delivery performance of the circulation pump 27. Next, a step of generating drive signals for driving the circulation pump 27 based on control signals and a reference voltage is explained.

### Pump Drive Circuit

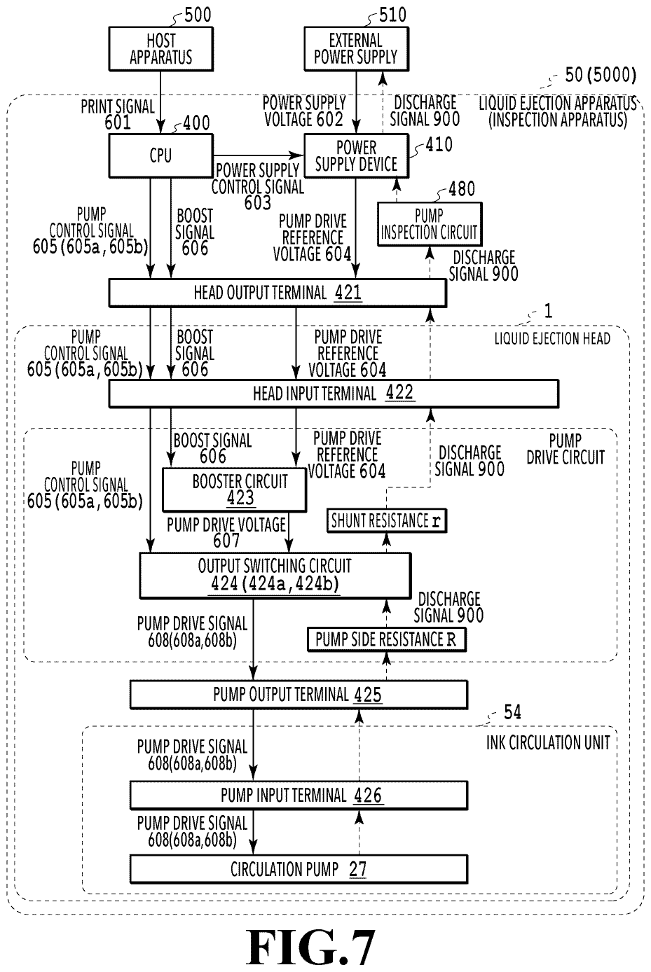

FIG. 7 is a diagram illustrating a configuration schematic diagram of a pump drive circuit that drives the circulation pump 27 of FIG. 6 in the first embodiment. The main body side of the liquid ejection apparatus 50 includes a pump inspection circuit 480 in addition to the CPU 400, a power supply device 410, and a head output terminal 421. The liquid ejection head 1 includes a shunt resistance r and a pump side resistance R in addition to a head input terminal 422, a booster circuit 423, an output switching circuit 424, and pump output terminals 425 as well as the ink circulation unit 54. The head output terminal 421 supplies various signals and various voltages to the head input terminal 422. The various signals include the pump control signals 605, a boost signal 606, and the like. The various voltages include the pump drive reference voltage 604. Details of each of the pump control signals 605, the boost signal 606, and the pump drive reference voltage 604 are described later. Moreover, the head input terminal 422 supplies a discharge signal 900 to the head output terminal 421. Details of the discharge signal 900 are described later. Furthermore, the booster circuit 423, the output switching circuit 424, the shunt resistance r, and the pump side resistance R among the head input terminal 422, the booster circuit 423, the output switching circuit 424, the pump output terminals 425, the shunt resistance r, and the pump side resistance R function as the pump drive circuit.

A print signal 601 as image data is inputted from the host apparatus 500 into the CPU 400 included in the main body side of the liquid ejection apparatus 50. Meanwhile, a power supply voltage 602 is supplied from an external power supply 510 to the power supply device 410 included in the main body side of the liquid ejection apparatus 50. The CPU 400 sets a power supply control signal 603 to the power supply device 410 to active by receiving the print signal 601 from the host apparatus 500. Note that, in the present embodiment, the power supply control signal 603 is assumed to be high-active. In other words, setting is assumed to be such that, in the case where the power supply control signal 603 is high, the power supply device 410 operates. Specifically, in the case where a signal potential of the power supply control signal 603 transitions from 0 V to 3.3 V, the power supply device 410 outputs the pump drive reference voltage 604 to the head output terminal 421. In the present embodiment, the pump drive reference voltage 604 is assumed to be 24 V. The CPU 400 receives the print signal 601 from the host apparatus 500, and outputs the pump control signals 605 and the boost signal 606 to the head output terminal 421.

### Pump Control Signals 605

The pump control signals 605 include the pump control signal 605a and the pump control signal 605b. The pump control signal 605a and the pump control signal 605b correspond to the first electrode 272 and the second electrode 274, respectively. The pump control signals 605a and 605b are sent to the output switching circuit 424 via the head output terminal 421 and the head input terminal 422. Transitioning the signal potentials of the respective pump control signals 605a and 605b from 0 V to 3.3 V sets the pump control signals 605a and 605b to active. Specifically, each of the pump control signals 605a and 605b is assumed to be high-active.

### Boost Signal 606

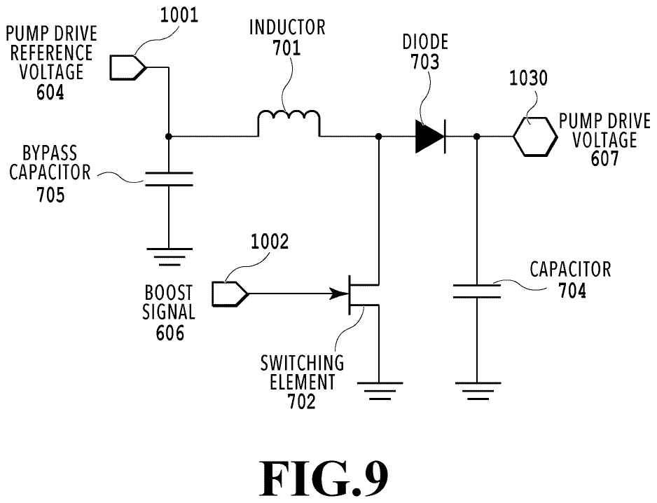

Transitioning of a signal potential of the boost signal 606 from 0 V to 24 V that is an active potential causes the booster circuit 423 to be driven. Specifically, the head output terminal 421 is a terminal provided on the main body side of the liquid ejection apparatus 50. The head output terminal 421 supplies various signals and various voltages to the head input terminal 422 provided on the liquid ejection head 1 side. In the present embodiment, the highest voltage among the voltages outputted from the head output terminal 421 is assumed to be 24 V. Accordingly, the voltages outputted from the head output terminal 421 are assumed to be relatively low voltages. The head output terminal 421 supplies the pump control signals 605, the boost signal 606, and the pump drive reference voltage 604 to the head input terminal 422. The head input terminal 422 supplies the pump drive reference voltage 604 supplied from the head output terminal 421, to a voltage input terminal 1001 of the booster circuit 423. The voltage input terminal 1001 is described later by using FIG. 9. The head input terminal 422 supplies the boost signal 606 supplied from the head output terminal 421, to a signal input terminal 1002 of the booster circuit 423. The signal input terminal 1002 is described later by using FIG. 9. The booster circuit 423 converts the pump drive reference voltage 604 of 24 V to a predetermined voltage necessary for sufficient displacement of the piezoelectric element 273 provided in the circulation pump 27, according to the boost signal 606. For example, the booster circuit 423 converts the pump drive reference voltage 604 of 24 V to a voltage of 72 V. Specifically, in the present embodiment, a boost setting center voltage is assumed to be 72 V. The booster circuit 423 outputs a voltage converted to 72 V, to the output switching circuit 424 as the pump drive voltage 607. A specific circuit example of the booster circuit 423 is described by using FIG. 9.

### Output Switching Circuit 424

The output switching circuit 424 outputs the pump drive voltage 607 to the pump output terminals 425 as the pump drive signals 608, according to the pump control signals 605 received from the head input terminal 422. The pump drive signals 608 include the pump drive signal 608a and the pump drive signal 608b. Details of the output switching circuit 424 are described later by using FIG. 10.

### Pump Output Terminals 425

The pump output terminals 425 are formed of a pump output terminal 425a and a pump output terminal 425b corresponding to the first electrode 272 and the second electrode 274, respectively. The pump output terminals 425 are provided in the head substrate 210. The pump drive signal 608a out of the pump drive signals 608a and 608b is outputted to the pump output terminal 425a. The pump drive signal 608b out of the pump drive signals 608a and 608b is outputted to the pump output terminal 425b. The potentials of the pump drive signals 608a and 608b transition between 0 V and 72 V at a pump drive frequency. In this example, 72 V is set as the pump drive voltage 607 of the circulation pump 27. The pump drive signals 608a and 608b outputted from the respective pump output terminals 425a and 425b are inputted into a pump input terminal 426 provided in the ink circulation unit 54 via the harnesses 211a and 211b.

### Ink Circulation Unit 54

The ink circulation unit 54 includes the pump input terminal 426 and the circulation pump 27 as the configurations relating to the pump drive signals 608a and 608b. The pump drive signals 608a and 608b sent from the pump output terminals 425a and 425b, respectively, are inputted into the pump input terminal 426. The pump input terminal 426 outputs the pump drive signals 608a and 608b to the circulation pump 27. The circulation pump 27 is driven according to the pump drive signals 608a and 608b outputted from the pump input terminal 426. The drive of the circulation pump 27 is described later by using FIG. 11.

Next, an outline of a feature of the present disclosure is explained. The feature of the present disclosure is a configuration in which the electric connection state of the circulation pump 27 and the piezoelectric capacitance of the piezoelectric element 273 can be inspected in a simple way. The charge stored in the piezoelectric element 273 is discharged to inspect the electric connection state of the circulation pump 27 and the piezoelectric capacitance of the piezoelectric element 273 in a simple way. Next, an outline of a discharge path for discharging the charge stored in the piezoelectric element 273 is explained.

### Outline of Discharge Path

Supplying the pump drive signals 608 to the circulation pump 27 causes charging and discharging of the charge to and from the piezoelectric element 273 to be repeated in the case where the circulation pump 27 is driven. The feature of the present disclosure is such that the electric connection state of the circulation pump 27 and the electric capacitance (piezoelectric capacitance) of the piezoelectric element 273 are detected by detecting, as the discharge signal 900, a current flowing in the case where the charge stored in the piezoelectric element 273 is discharged.

The output switching circuit 424 in the pump drive circuit controls the charge stored in the piezoelectric element 273, and the charge is discharged to the GND side of the liquid ejection apparatus 50 or an inspection apparatus 5000 via the electric connection portion 212. This discharge signal 900 is used as an original signal by the pump inspection circuit 480 provided on the liquid ejection apparatus 50 side or the inspection apparatus 5000 side to perform signal detection, and the electric connection state of the circulation pump 27 and the electric capacitance (piezoelectric capacitance) of the piezoelectric element 273 are thereby detected. Note that a signal with a potential reduced from the potential of the discharge signal 900 may be supplied to the pump inspection circuit 480. Reduction of the potential of the discharge signal 900 can reduce the potential of the signal to be supplied to the main body side of the liquid ejection apparatus 50. This enables a safer operation.

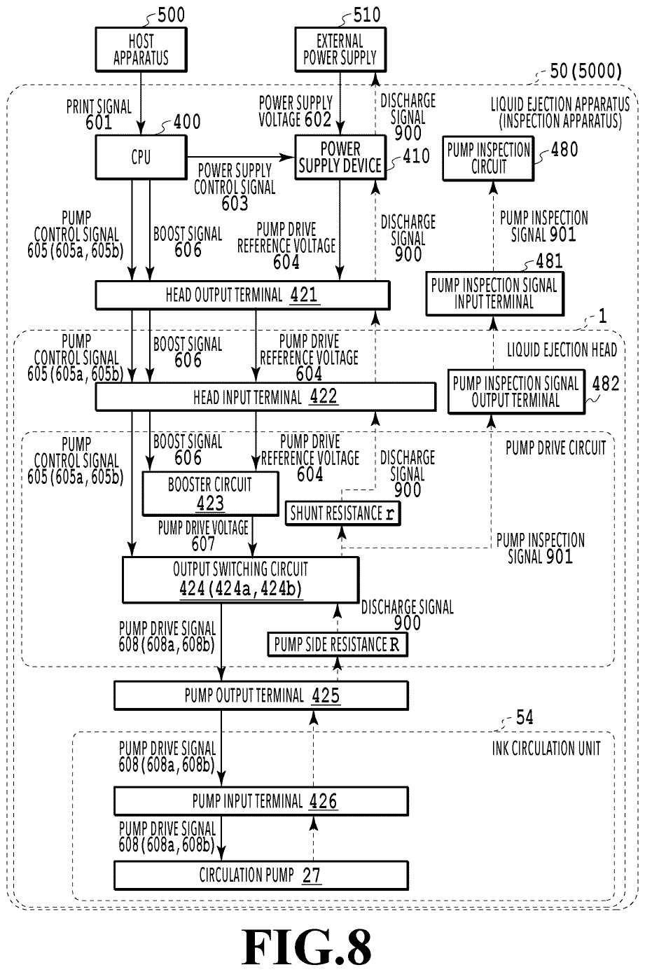

In other words, the head output terminal 421 and the head input terminal 422 are an electric connection terminal group in the present embodiment. This electric connection terminal group electrically connects the liquid ejection head 1 and the liquid ejection apparatus 50 to each other, and also allows the liquid ejection head 1 to be freely attached and detached. Similarly, in the inspection apparatus 5000, the electric connection terminal group electrically connects the liquid ejection head 1 and the liquid ejection apparatus 50 to each other, and also allows the liquid ejection head 1 to be freely attached and detached. Next, an example in which the signal with the potential reduced from the potential of the discharge signal 900 is supplied to the pump inspection circuit 480 is explained by using FIG. 8.

FIG. 8 is a diagram illustrating another configuration schematic diagram of the pump drive circuit that drives the circulation pump 27 of FIG. 6 in the first embodiment. Differences from FIG. 7 are mainly explained for FIG. 8. As described in detail later by using FIG. 10, in the discharge path from the circulation pump 27, the pump side resistance R is provided on the circulation pump 27 side, and the shunt resistance r is provided on the GND side. The pump side resistance R and the shunt resistance r are in a series connection relationship. A voltage signal outputted from a signal output terminal 1020 (described later in FIG. 10) between the pump side resistance R and the shunt resistance r is outputted as a pump inspection signal 901. The pump inspection signal 901 is supplied to a pump inspection signal input terminal 481 provided on a main body side of the liquid ejection apparatus 50 via a pump inspection signal output terminal 482 provided in the liquid ejection head 1. The pump inspection signal 901 supplied to the pump inspection signal input terminal 481 is supplied to the pump inspection circuit 480.

Note that the feature of the present disclosure can be applied to the liquid ejection apparatus 50. Moreover, the feature of the present disclosure can be also applied to the inspection apparatus 5000 in a manufacturing process of the liquid ejection head 1. A configuration of the inspection apparatus 5000 is similar to the liquid ejection apparatus 50. Moreover, although the present embodiment describes the example in which the pump drive circuit that generates the pump drive signals 608 of the circulation pump 27 is provided in the liquid ejection head 1 as described in detail later, the present disclosure is not limited to this example. For example, the pump drive circuit as described above may be provided on the main body side of the liquid ejection apparatus 50. Alternatively, the pump drive circuit as described above may be provided in the inspection apparatus.

### Booster Circuit 423

FIG. 9 is a diagram illustrating a circuit configuration example of the booster circuit 423 of FIGS. 7 and 8 in the first embodiment. In the example of FIG. 9, the booster circuit 423 includes a bypass capacitor 705, an inductor 701, a switching element 702, a diode 703, and a capacitor 704. For example, a chip inductor is used as the inductor 701. For example, an n-channel FET is used as the switching element 702. In FIG. 9, the ground provides a potential to be an operation reference of the circuit. For example, the ground is formed of a ground terminal as frame ground or signal ground. Alternatively, the ground may be formed of a ground terminal as frame earth or signal earth. Note that the GND side described above means the same potential side as the ground terminal.

### Connection Configuration of Booster Circuit 423

One terminal of the bypass capacitor 705 is connected to the ground terminal. The other terminal of the bypass capacitor 705 is connected to the voltage input terminal 1001 of the booster circuit 423. The pump drive reference voltage 604 is applied to the voltage input terminal 1001 of the booster circuit 423. Moreover, one terminal of the inductor 701 is connected to the voltage input terminal 1001 of the booster circuit 423. The other terminal of the inductor 701 is connected to the anode of the diode 703 and the drain of the switching element 702. The source of the switching element 702 is connected to the ground terminal. Inputting the boost signal 606 received from the signal input terminal 1002 of the booster circuit 423 into the gate of the switching element 702 achieves a conductive state between the drain and the source of the switching element 702. One terminal of the capacitor 704 is connected to the cathode of the diode 703. The other terminal of the capacitor 704 is connected to the ground terminal. Moreover, a voltage output terminal 1030 is also connected to the cathode of the diode 703. The voltage output terminal 1030 of the booster circuit 423 can output the pump drive voltage 607.

### Operation of Booster Circuit 423

In the case where the potential of the boost signal 606 transitions from the ground potential to the state of 24 V that is the active potential, the switching element 702 goes into the conductive state. Accordingly, in a state where the pump drive reference voltage 604 is applied to the voltage input terminal 1001 of the booster circuit 423, a current flows from the voltage input terminal 1001 of the booster circuit 423 to the ground terminal via the inductor 701 and the switching element 702. If the potential of the boost signal 606 transitions from the active potential to the ground potential in this case, the switching element 702 goes into a non-conductive state, and back electromotive force is generated in the inductor 701. Accordingly, a current generated by the back electromotive force of the inductor 701 flows to the capacitor 704 via the diode 703. A charge thereby flows into the capacitor 704. The charge flowing into and stored in the capacitor 704 cannot return to the anode side of the diode 703 due to the diode 703. Accordingly, repeating the conductive state and the non-conductive state of the switching element 702 by using the boost signal 606 causes the charge to flow into and be stored in the capacitor 704. As a result, the pump drive voltage 607 is boosted to a higher voltage than the pump drive reference voltage 604. In the present embodiment, the boost signal 606 is inputted into the switching element 702 such that the pump drive reference voltage 604 becomes 72 V. Note that the booster circuit 423 is not limited to the example of FIG. 9. For example, the booster circuit 423 may be formed of a charge pump circuit. Alternatively, the booster circuit 423 may be formed of a power supply unit that converts an alternating current inputted from the outside to a direct current of 72 V.

FIG. 10 is a diagram illustrating a circuit configuration example of the output switching circuit 424 of FIGS. 7 and 8 in the first embodiment. The output switching circuit 424 includes a first voltage control circuit 424a and a second voltage control circuit 424b. The first voltage control circuit 424a and the second voltage control circuit 424b are provided in parallel. In a state where the first voltage control circuit 424a is receiving the pump drive voltage 607 via a voltage input terminal 1031, the first voltage control circuit 424a outputs the pump drive signal 608a via a signal output terminal 1010 based on input of the pump control signal 605a via a signal input terminal 1003. The first voltage control circuit 424a includes an a signal system corresponding to the first electrode 272. The a signal system controls output of the pump drive signal 608a to the first electrode 272 via the first wiring line 211a. Accordingly, the a signal system can control the voltage applied to the first electrode 272. In a state where the second voltage control circuit 424b is receiving the pump drive voltage 607 via the voltage input terminal 1031, the second voltage control circuit 424b outputs the pump drive signal 608b via a signal output terminal 1011 based on input of the pump control signal 605b via a signal input terminal 1004. The second voltage control circuit 424b includes a b signal system corresponding to the second electrode 274. The b signal system controls output of the pump drive signal 608b to the second electrode 274 via the second wiring line 211b. Accordingly, the b signal system can control the voltage applied to the second electrode 274.

### Connection Configuration of First Voltage Control Circuit 424a

The first voltage control circuit 424a includes a resistor 801a, a transistor 802a, a transistor 803a, a transistor 805a, and a capacitor 806a. The transistor 802a is formed of an NPN transistor. The transistor 803a is formed of a PNP transistor. The transistor 805a is formed of an NPN transistor. One terminal of the resistor 801a is connected to a collector of the transistor 802a. The collector of the transistor 802a is connected to a voltage input terminal of the pump drive voltage 607. The other terminal of the resistor 801a is connected to the base of the transistor 802a. The base of the transistor 803a, one terminal of the capacitor 806a, and the collector of the transistor 805a are connected to the base of the transistor 802a. The emitter of the transistor 803a is connected to the emitter of the transistor 802a. The pump drive signal 608a can be outputted from a signal output terminal provided between the emitter of the transistor 803a and the emitter of the transistor 802a. The pump control signal 605a is inputted into the base of the transistor 805a. The emitter of the transistor 805a and the other terminal of the capacitor 806a are connected to the ground terminal. Note that the switching elements of the first voltage control circuit 424a are not limited to the transistors 802a, 803a, and 805a. The switching elements of the first voltage control circuit 424a may be FETs.

### Operations of First Voltage Control Circuit 424a

### Potential of Pump Control Signal 605a: Ground Potential

In a state where the potential of the pump control signal 605a is the ground potential, a portion between the emitter and the collector of the transistor 805a is in the non-conductive state. Accordingly, the transistor 805a is open (open circuit). In the case where the transistor 805a is open, the pump drive voltage 607 is applied to the base of the transistor 802a and the base of the transistor 803a. In this case, if the potential of the pump drive signal 608a is the ground potential, the potential of the emitter of the transistor 802a is the ground potential. Accordingly, the potential of the emitter of the transistor 802a is lower than the potential of the base of the transistor 802a. Thus, a base current flows from the base of the transistor 802a to an output destination of the pump drive signal 608a. Accordingly, the transistor 802a becomes active, and a voltage with the same potential as the pump drive voltage 607 is outputted as the pump drive signal 608a. In this case, the outputted voltage is 72 V. Meanwhile, the potential of the emitter of the transistor 803a and the potential of the base of the transistor 803a are the same potential. Accordingly, the transistor 803a is open (open circuit). Based on the above, in the state where the potential of the pump control signal 605a is the ground potential, the potential of the pump drive signal 608a is the potential of the pump drive voltage 607.

### Potential of Pump Control Signal 605a: Active Potential

In a state where the potential of the pump control signal 605a is the active potential, a base current flows from the base of the transistor 805a to the emitter of the transistor 805a. Accordingly, the transistor 805a becomes active, and the base of the transistor 802a and the base of the transistor 803a are connected to the ground terminal. In this case, if the potential of the pump drive signal 608a is 72 V, the base current flows from the emitter of the transistor 803a to the base of the transistor 803a. Thus, the transistor 803a becomes active. In the case where the transistor 803a is active, a portion between the emitter of the transistor 803a and the collector of the transistor 803a are in the conductive state, and the collector of the transistor 803a is connected to the ground terminal. The potential of a portion between the emitter of the transistor 802a and the emitter of the transistor 803a thereby becomes the ground potential. Meanwhile, since the potential of the base of the transistor 802a and the potential of the emitter of the transistor 802a are the same potential, the transistor 802a is open (open circuit). Based on the above, in the state where the potential of the pump control signal 605a is the active potential, the potential of the pump drive signal 608a is the ground potential.

### Connection Configuration of Second Voltage Control Circuit 424b

The second voltage control circuit 424b includes a resistor 801b, a transistor 802b, a transistor 803b, a transistor 805b, and a capacitor 806b. The transistor 802b is formed of an NPN transistor. The transistor 803b is formed of a PNP transistor. The transistor 805b is formed of an NPN transistor. One terminal of the resistor 801b is connected to the collector of the transistor 802b. The collector of the transistor 802b is connected to the voltage input terminal of the pump drive voltage 607. The other terminal of the resistor 801b is connected to the base of the transistor 802b. The base of the transistor 803b, one terminal of the capacitor 806b, and the collector of the transistor 805b are connected to the base of the transistor 802b. The emitter of the transistor 803b is connected to the emitter of the transistor 802b. The pump drive signal 608b can be outputted from a signal output terminal provided between the emitter of the transistor 803b and the emitter of the transistor 802b. The pump control signal 605b is inputted into the base of the transistor 805b. The emitter of the transistor 805b and the other terminal of the capacitor 806b are connected to the ground terminal. Note that the switching elements of the second voltage control circuit 424b are not limited to the transistors 802b, 803b, and 805b. The switching elements of the second voltage control circuit 424b may be FETs.

### Operations of Second Voltage Control Circuit 424b

### Potential of Pump Control Signal 605b: Ground Potential

In a state where the potential of the pump control signal 605b is the ground potential, a portion between the emitter and the collector of the transistor 805b are in the non-conductive state. Accordingly, the transistor 805b is open (open circuit). In the case where the transistor 805b is open, the pump drive voltage 607 is applied to the base of the transistor 802b and the base of the transistor 803b. In this case, if the potential of the pump drive signal 608b is the ground potential, the potential of the emitter of the transistor 802b is the ground potential. Accordingly, the potential of the emitter of the transistor 802b is lower than the potential of the base of the transistor 802b. Thus, a base current flows from the base of the transistor 802b to an output destination of the pump drive signal 608b. Accordingly, the transistor 802b becomes active, and the pump drive voltage 607 is outputted as the pump drive signal 608b. In this case, the outputted voltage is 72 V. Meanwhile, the potential of the emitter of the transistor 803b and the potential of the base of the transistor 803b are the same potential. Accordingly, the transistor 803b is open (open circuit). Based on the above, in the state where the potential of the pump control signal 605b is the ground potential, the potential of the pump drive signal 608b is the potential of the pump drive voltage 607.

### Potential of Pump Control Signal 605b: Active Potential

In a state where the potential of the pump control signal 605b is the active potential, a base current flows from the base of the transistor 805b to the emitter of the transistor 805b. Accordingly, the transistor 805b becomes active, and the base of the transistor 802b and the base of the transistor 803b are connected to the ground terminal. In this case, if the potential of the pump drive signal 608b is 72 V, the base current flows from the emitter of the transistor 803b to the base of the transistor 803b. Thus, the transistor 803b becomes active. In the case where the transistor 803b is active, the emitter of the transistor 803b and the collector of the transistor 803b are in the conductive state, and the collector of the transistor 803b is connected to the ground terminal. Accordingly, a portion between the emitter of the transistor 802b and the emitter of the transistor 803b are connected to the ground terminal. The potential of the pump drive signal 608b thereby becomes the ground potential. Meanwhile, since the potential of the base of the transistor 802b and the potential of the emitter of the transistor 802b are the same potential, the transistor 802b is open (open circuit). Based on the above, in the state where the potential of the pump control signal 605b is the active potential, the potential of the pump drive signal 608b is the ground potential.

Based on the above, outputting the pump control signal 605a and the pump control signal 605b while alternately switching the potential of the pump control signal 605a and the potential of the pump control signal 605b to the active potential causes the output switching circuit 424 to alternately output the pump drive signal 608a and the pump drive signal 608b. Next, details of the discharge path are explained.

### Details of Discharge Path

The transistors 802a, 803a and 805a perform control such that an inter-terminal voltage of the piezoelectric element 273 is alternately switched between a high state and a low state. In the case where the inter-terminal voltage of the circulation pump 27 drops to the low state, the charge stored in the piezoelectric element 273 is discharged. Specifically, the discharge signal 900 flows along the path of the dot-dash line arrow in FIG. 10. The pump side resistance R and the shunt resistance r are arranged in series in the discharge path. The signal output terminal 1020 is provided between the pump side resistance R and the shunt resistance r. Accordingly, the potential of the discharge signal 900 can be outputted while being divided by the pump side resistance R and the shunt resistance r. The potential of the pump inspection signal 901 outputted from the signal output terminal 1020 is thus the potential outputted by dividing the potential of the discharge signal 900. Note that at least one set of circuit configuration in which the pump side resistance R and the shunt resistance r are connected in series is present in the discharge path. Accordingly, multiple sets of circuit configuration in which the pump side resistance R and the shunt resistance r are connected in series may be present in the discharge path. In the case where multiple sets are present, the sets are connected in series. Accordingly, the more the sets of circuit configuration in which the pump side resistance R and the shunt resistance r are connected in series are arranged in series, the more the current value of the discharge signal 900 is reduced.

Moreover, in many cases, a high-voltage signal is necessary for a drive voltage Vp of the pump drive signals 608 inputted into the piezoelectric element 273. However, in the case where a contact connection from the outside is possible like the pump inspection signal 901, the drive voltage Vp is desirably set to a threshold voltage of 42.4 V or lower in consideration of effects on the outside. Accordingly, the drive voltage Vp, the pump side resistance R, and the shunt resistance r desirably satisfy the relationship of the following formula (1).

$$r / ( R + r ) \times Vp \leq 42.4 V \qquad ( 1 )$$

The pump inspection circuit 480 desirably satisfies the relationship of the following formula (2) in consideration of a degree of freedom in selection of an element depending on the tolerance level.

$$r / ( R + r ) \times Vp \leq 5 V \qquad ( 2 )$$

Note that the threshold voltage of 5 V can be changed as appropriate depending on a device configuration in which the pump inspection circuit 480 is implemented. Next, drive of the circulation pump 27 is explained.

### Drive of Circulation Pump 27

FIG. 11 is a timing chart of control signals for controlling the pump drive circuit of FIGS. 7 and 8 in the first embodiment. First, the potential of the pump drive reference voltage 604 transitions from 0 V to 24 V. This transition causes the pump drive reference voltage 604 to be applied to the booster circuit 423. Next, transition of the potential of the boost signal 606 from 0 V to 24 V is repeated according to a certain rule. For example, the potential of the boost signal 606 repeatedly becomes 0 V and 24 V based on a certain duty ratio. This repetition boosts the potential of the pump drive voltage 607 outputted from the booster circuit 423 from 0 V to 72 V. The boosted pump drive voltage 607 is applied to the output switching circuit 424. In the output switching circuit 424, the potentials of the respective pump drive signals 608a and 608b increase to 72 V with the application of the pump drive voltage 607, and reach the same potential as the potential of the pump drive voltage 607.

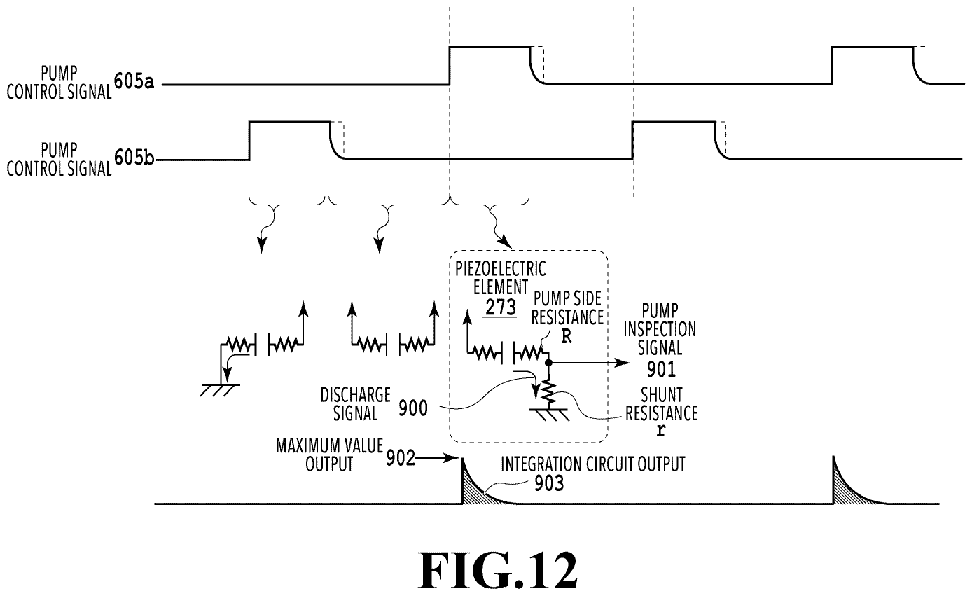

Note that, in the present embodiment, the potentials of the various signals between the liquid ejection head 1 and the liquid ejection apparatus 50 are potentials that are relatively not high. The various voltages between the liquid ejection head 1 and the liquid ejection apparatus 50 are also voltages that are relatively not high. Accordingly, in an electric connection configuration in which the pump inspection signal 901 is detected from the liquid ejection head 1, a configuration for handling high voltages is unnecessary, and size reduction and simplification of configuration are possible. Next, the discharge signal 900 and the pump inspection signal 901 that are the feature of the present disclosure are specifically explained by using FIG. 12.

FIG. 12 is a diagram explaining an operation principle of detecting the electric connection state of the circulation pump 27 and the electric capacitance of the piezoelectric element 273 in the first embodiment. As explained above, the inter-terminal voltage of the piezoelectric element 273 is controlled to be the low state and the high state by inputting the pump drive signals 608a and 608b into the circulation pump 27. In the case where the potential of the pump control signal 605b is in the high state and the potential of the pump control signal 605a is in the low state, one end of the piezoelectric element is boosted to the drive voltage Vp, and the other end is dropped to the ground. Specifically, the piezoelectric element goes into a state where it receives charging of the charge while discharging the charge to the ground.

Meanwhile, in the case where the potentials of the pump control signals 605a and 605b are in the low state, the inter-terminal voltage of the piezoelectric element 273 is boosted to the drive voltage Vp, and the charge is continuously charged. In the case where this state continues for a certain period, the piezoelectric element 273 goes into a charge saturation state, and no more charge can be stored in the piezoelectric element 273.

From the state where the charge stored in the piezoelectric element 273 saturates as described above, the potential of the pump control signal 605a is transitioned to the high state and the potential of the pump control signal 605b is transitioned to the low state to set the potential of the one end (pump side resistance R connection side) of the piezoelectric element 273 to the low state. This transition causes the discharge signal 900 to flow in the pump side resistance R and the shunt resistance r. The pump inspection signal 901 is thereby generated. Specifically, the CPU 400 performs control such that the transition of the potential of the pump control signal 605a to the high state and the transition of the potential of the pump control signal 605b to the low state are delayed until the charge stored in the piezoelectric element 273 goes into the saturation state.

The maximum value of the voltage of the pump inspection signal 901 instantaneously flowing in the case where the charge stored in the piezoelectric element 273 is discharged from the saturation state is constant irrespective of the electric capacitance of the piezoelectric element 273. Accordingly, the number of the connected piezoelectric elements 273 can be determined by detecting the maximum value of the voltage of the pump inspection signal 901. Specifically, electric connection inspection of the circulation pump 27 can be performed. Time constants of the voltage of the pump inspection signal 901 and the current of the discharge signal 900 instantaneously flowing in the case where the charge stored in the piezoelectric element 273 is discharged from the saturation state change depending on the electric capacitance of the piezoelectric element 273. This is due to a difference in the amount of charge stored in the piezoelectric element 273. Accordingly, the electric capacitance of the piezoelectric element 273 can be detected by obtaining an integrated value of the current of the pump inspection signal 901.

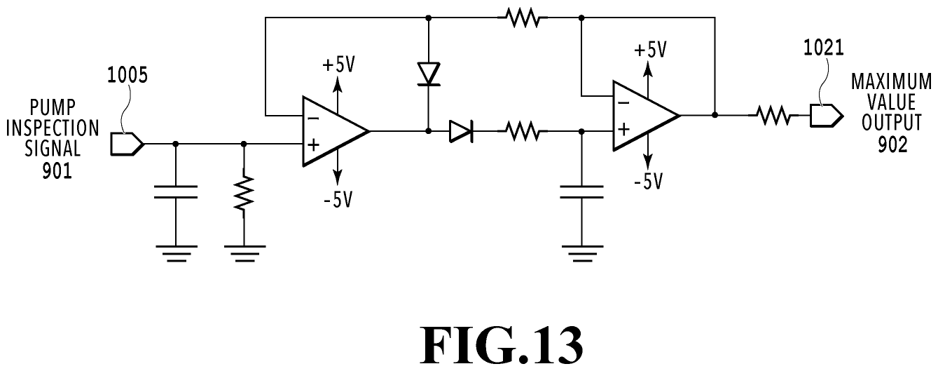

FIG. 13 is a diagram illustrating an example of a maximum value output circuit for obtaining the maximum value of the pump inspection signal 901 of FIG. 12 in the first embodiment. The maximum value output circuit of FIG. 13 is a circuit that detects the maximum value of the voltage of the pump inspection signal 901 received from a signal input terminal 1005 and holds the maximum value for a certain time period. The maximum value output circuit of FIG. 13 includes operational amplifiers, a capacitor, and diodes. In the case where the voltage of the pump inspection signal 901 reaches a peak value, the diodes become conductive in the forward direction, and the capacitor is charged. In this case, an inter-terminal voltage of the capacitor is equal to the maximum value of the voltage of the pump inspection signal 901. Thereafter, in the case where the voltage of the pump inspection signal 901 falls below the maximum value, the diodes are biased in the reverse direction, and become non-conductive. The capacitor thereby keeps holding the charged voltage. This held voltage is outputted to detect the maximum value of the voltage of the pump inspection signal 901 and perform the connection inspection of the circulation pump 27.

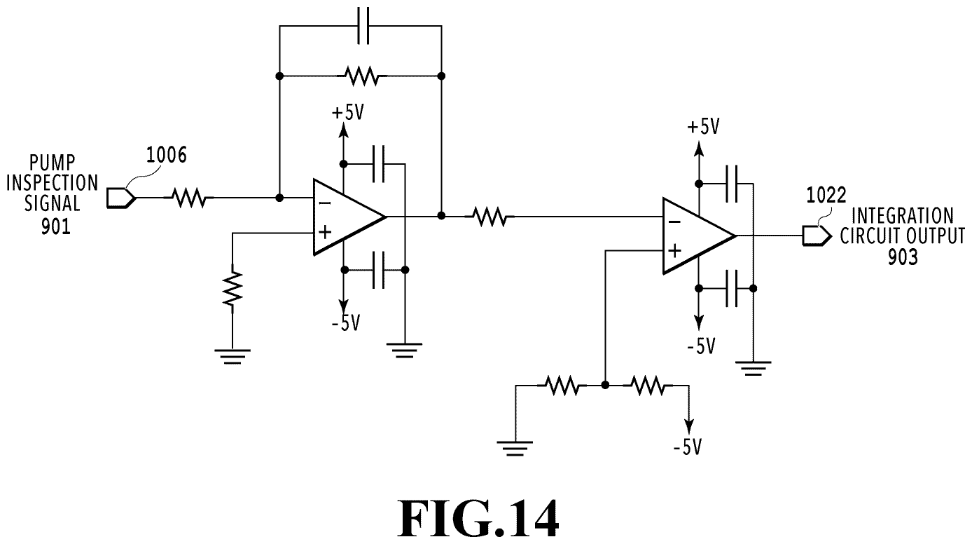

FIG. 14 is a diagram illustrating an example of an integration circuit for obtaining the integrated value of the current of the pump inspection signal 901 in FIG. 12 in the first embodiment. The integration circuit of FIG. 14 includes operational amplifiers. Moreover, a capacitor is arranged on the feedback side of an inverting amplifier. The circuit configuration as described above allows a time integration result of an input waveform of a current of the pump inspection signal 901 received from a signal input terminal 1006 to be outputted from a signal output terminal 1022. Moreover, an inverting amplifier circuit is arranged in a stage subsequent to the integration circuit of FIG. 14. An integrated value with a positive sign can be thereby outputted. An output corresponding to the electric capacitance of the piezoelectric element 273 can be obtained by obtaining this integral output.

As explained above, according to the configuration of the present disclosure, there is used an indirect inspection method that uses the pump inspection circuit 480 and the resistances provided in the discharge path of the charge, without establishing a direct contact between the terminals of the piezoelectric element 273. The electric connection state of the circulation pump 27 and the electric capacitance of the piezoelectric element 273 can be thereby measured in a simple way.

Moreover, introducing this inspection method to the inspection apparatus 5000 in the manufacturing process of the liquid ejection head 1 allows electrical certification in shipping to be executed in a simple way. Furthermore, introducing this inspection method to the liquid ejection apparatus 50 in the manufacturing process of the liquid ejection head 1 enables the following matters. Firstly, it is possible to detect electric connection abnormality after mounting of the liquid ejection head 1 on the liquid ejection apparatus 50 side and execute error stop. Secondly, it is possible to detect the electric capacitance of the piezoelectric element 273 on the liquid ejection apparatus 50 side and perform pump drive control depending on the electric capacitance of the piezoelectric element 273 to maintain the circulation flow rate of the liquid at a certain level. Thirdly, since the electric capacitance of the piezoelectric element 273 can be detected, control taking the manufacturing variation of the piezoelectric element 273 into consideration can be also performed.

### Second Embodiment

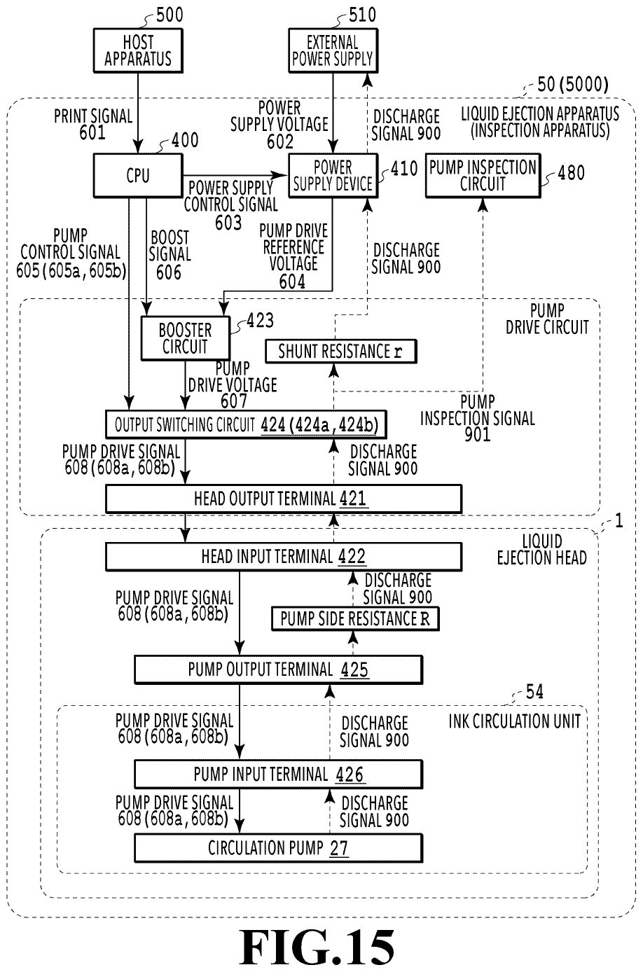

FIG. 15 is a diagram illustrating a configuration schematic diagram of a pump drive circuit that drives the circulation pump 27 of FIG. 6 in a second embodiment. The present embodiment is different from the first embodiment in that the pump drive circuit configured to generate the pump drive signals 608a and 608b of the circulation pump 27 is provided on the main body side of the liquid ejection apparatus 50 or the main body side of the inspection apparatus 5000. Differences from the first embodiment are mainly explained below.

The pump drive signals 608a and 608b generated on the main body side of the liquid ejection apparatus 50 or the inspection apparatus 5000 are inputted into the liquid ejection head 1 from the head input terminal 422 via the head output terminal 421 to be supplied to the circulation pump 27. Specifically, the head output terminal 421 and the head input terminal 422 are the electric connection terminal group in the present embodiment. This electric connection terminal group electrically connects the liquid ejection head 1 and the liquid ejection apparatus 50 to each other, and allows the liquid ejection head 1 to be freely attached and detached. Similarly, also in the inspection apparatus 5000, the electric connection terminal group electrically connects the liquid ejection head 1 and the inspection apparatus 5000 to each other, and allows the liquid ejection head 1 to be freely attached and detached.

The charge stored in the piezoelectric element 273 is discharged to the ground via the discharge path as in the first embodiment. The discharge path is similar to that in the first embodiment in that the pump side resistance R and the shunt resistance r are connected in series. However, in the present embodiment, the pump side resistance R is provided in the liquid ejection head 1, while the shunt resistance r is provided on the main body side of the liquid ejection apparatus 50 or the inspection apparatus 5000. The arrangement positions of the pump side resistance R and the shunt resistance r are not limited, and may be inside the liquid ejection head 1 or on the main body side of the liquid ejection apparatus 50. Alternatively, both of the pump side resistance R and the shunt resistance r may be arranged on the main body side of the liquid ejection apparatus 50. Moreover, the arrangement of the pump inspection circuit 480 is not limited, and the pump side resistance R, the shunt resistance r, and the pump inspection circuit 480 may be arranged inside the liquid ejection head 1.

### Third Embodiment

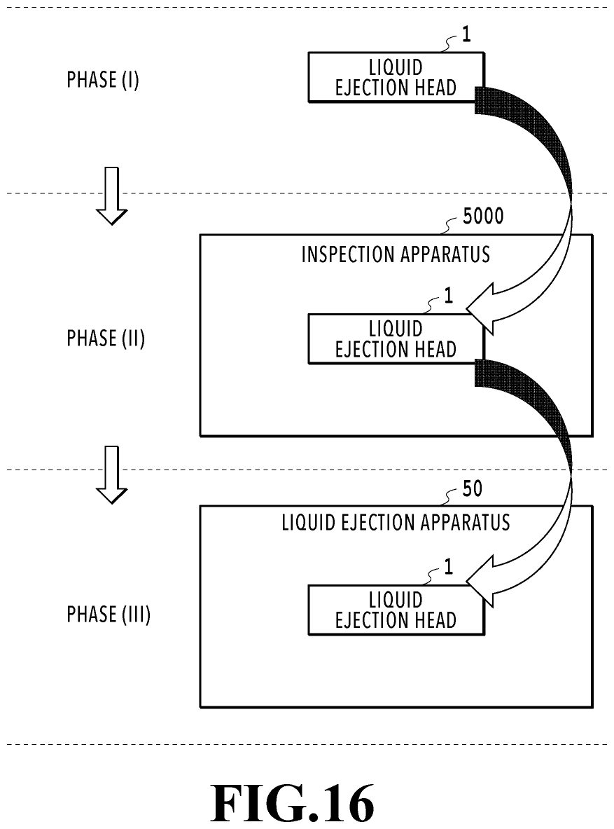

FIG. 16 is a schematic diagram explaining a configuration example in each of phases of assembly, inspection, and shipping of the liquid ejection head 1 in a third embodiment. Phase (I) illustrates a phase in which the liquid ejection head 1 is manufactured in a manufacturing line. Phase (II) illustrates a phase in which the manufactured liquid ejection head 1 is mounted in the inspection apparatus 5000, and is subjected to electric connection inspection. Phase (III) illustrates a phase in which the liquid ejection head 1 that has passed the inspection is incorporated in the liquid ejection apparatus 50, and is shipped. As described above, after the manufacturing of the liquid ejection head 1, the electric connection inspection is performed by using the inspection apparatus 5000, and the liquid ejection head 1 that has passed the inspection is incorporated in the liquid ejection apparatus 50. Accordingly, electric connection inspection of the liquid ejection apparatus 50 can be executed in phase (II), and can be executed also in the liquid ejection apparatus 50 after shipping. Whether the electric connection state of the liquid ejection head 1 is deficient or not can be inspected before the shipping in a simple configuration. Moreover, whether the electric connection state of the liquid ejection head 1 is deficient or not can be inspected in the liquid ejection apparatus 50 also after the shipping in a simple configuration.

### Other Embodiments

Although various examples of the present disclosure are explained above by illustrating the embodiments, the spirit and the scope of the present disclosure are not limited to the specific explanation of the present specification. The present disclosure is not limited to the above-mentioned embodiments, and various modifications can be made. Moreover, in the present disclosure, parts of the above-mentioned embodiment may be combined as appropriate.

### Modified Example 1

For example, although the example in which the liquid ejection head 1 includes the booster circuit 423 is explained, the present disclosure is not particularly limited to this configuration. For example, the liquid ejection head 1 may include a DC-DC convertor. In the case where the DC-DC convertor has a boosting function, the DC-DC convertor can implement the functions of the booster circuit 423 and the like.

### Modified Example 2

Moreover, although the example in which the discharge path is provided in the a signal system is explained in the first embodiment, the present disclosure is not particularly limited to this configuration. The discharge path may be provided in the b signal system. Specifically, it is only necessary that the discharge path is provided in one of the a signal system and the b signal system.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, whether the piezoelectric element is normally, electrically connected or not can be inspected in a simple way.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-030003, filed Feb. 27, 2025, which is hereby incorporated by reference herein in its entirety.

What is claimed is:

1. A liquid ejection apparatus comprising:
a liquid ejection head; and
a detection unit electrically connectable to the liquid ejection head, wherein
the liquid ejection head includes
a circulation channel configured to have liquid be circulate, and
a circulation pump including a piezoelectric element and configured to control a circulation flow rate of the liquid circulating through the circulation channel by shape change of the piezoelectric element in accordance with an electric signal, and
the detection unit detects an electric connection state of the piezoelectric element based on a discharge signal generated with discharging of a charge stored in the piezoelectric element by the electric signal.

2. The liquid ejection apparatus according to claim 1, further comprising an electric connection terminal group configured to electrically connect the liquid ejection head and the detection unit to each other and allow the liquid ejection head to be freely attached and detached.

3. An inspection apparatus comprising:
a liquid ejection head;
a detection unit electrically connectable to the liquid ejection head; and
an electric connection terminal group configured to electrically connect the liquid ejection head and the detection unit to each other and allow the liquid ejection head to be freely attached and detached, wherein
the liquid ejection head includes
a circulation channel configured to have liquid be circulate, and
a circulation pump including a piezoelectric element and configured to control a circulation flow rate of the liquid circulating through the circulation channel by shape change of the piezoelectric element in accordance with an electric signal, and
the detection unit detects an electric connection state of the piezoelectric element based on a discharge signal generated with discharging of a charge stored in the piezoelectric element by the electric signal.

4. The inspection apparatus according to claim 3, further comprising a discharge path through configured to discharge the charge stored in the piezoelectric element, wherein
the discharge path includes
a pump side resistance,
a shunt resistance connected to the pump side resistance in series, and
a signal output terminal provided between the pump side resistance and the shunt resistance and configured to divide a potential of the discharge signal flowing through the discharge path and output the divided potential as a pump inspection signal, and
one end of the pump side resistance is connected to the piezoelectric element, and the other end of the pump side resistance is connected to the shunt resistance, and
one end of the shunt resistance is connected to the pump side resistance, and the other end of the shunt resistance is connected to a ground.

5. The inspection apparatus according to claim 4, wherein the pump side resistance is provided in the liquid ejection head.

6. The inspection apparatus according to claim 4, wherein the pump side resistance and the shunt resistance are provided in the liquid ejection head.

7. The inspection apparatus according to claim 4, wherein the pump side resistance is provided in the liquid ejection head, and the shunt resistance is provided outside the liquid ejection head.

8. The inspection apparatus according to claim 5, further comprising a booster circuit configured to boost a drive voltage for driving the circulation pump to a threshold voltage.

9. The inspection apparatus according to claim 8, wherein the threshold voltage is set to 42.4 V or lower.

10. The inspection apparatus according to claim 9, wherein a condition of
$$r / ( R + r ) \times Vp \leq 42.4 V$$
is satisfied, where Vp is the threshold voltage, R is the pump side resistance, and r is the shunt resistance.

11. The inspection apparatus according to claim 9, wherein a condition of
$$r / ( R + r ) \times Vp \leq 5 V$$
is satisfied, where Vp is the threshold voltage, R is the pump side resistance, and r is the shunt resistance.

12. The inspection apparatus according to claim 4, wherein the discharge path includes at least one pair of the pump side resistance and the shunt resistance.

13. The inspection apparatus according to claim 4, further comprising a maximum value detection unit configured to detect a maximum value of the pump inspection signal, wherein
the detection unit detects the number of the connected piezoelectric elements based on the maximum value.

14. The inspection apparatus according to claim 4, wherein
the pump side resistance and the shunt resistance are arranged between the piezoelectric element and the ground, and
the inspection apparatus further comprises a control unit configured to cause the discharge signal to flow from the piezoelectric element to the ground in case of detecting the pump inspection signal.

15. The inspection apparatus according to claim 14, wherein the control unit does not cause the discharge signal to flow until the charge stored in the piezoelectric element saturates.

16. The inspection apparatus according to claim 14, wherein the control unit obtains an integrated value up to a point where the potential of the discharge signal reaches zero.

17. A liquid ejection head comprising:
a circulation channel configured to have liquid be circulate;
a circulation pump including a piezoelectric element and configured to control a circulation flow rate of the liquid circulating through the circulation channel by shape change of the piezoelectric element in accordance with an electric signal; and
a signal output terminal configured to output a discharge signal generated with discharging of a charge stored in the piezoelectric element by the electric signal.
